(19) United States
(12) Patent Application Publication
(10) Pub. No.: US 2008/0098647 A1
(43) Pub. Date: May 1, 2008

(54) Method and system for protecting tree root systems

(76) Inventor: Delbert Sandlin, Lake Bluff, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/586,878

(22) Filed: Oct. 26, 2006

(51) Int. Cl. A01G 13/02

(52) U.S. Cl. 47/32

(57) ABSTRACT

A method of operating equipment around trees. The method includes the steps of: providing a plurality of modules; joining the plurality of modules to each other in an operative state at a site wherein the plurality of modules are placed against a ground surface over roots of at least one adjacent tree so that water can be directed at least one of (a) through at least one of the joined modules and (b) between the joined modules to be directed against, and evaporated from, the ground surface; moving equipment against the plurality of joined modules so that weight forces for the equipment are distributed through the plurality of modules over a substantial area of the ground surface to avoid application of concentrated forces that may inflict damage to the tree roots; and removing the plurality of modules from the site after moving the equipment against the plurality of joined modules.

### BACKGROUND OF THE INVENTION

1. Field of the Invention

This invention relates to a method and system for temporarily protecting tree root systems, as during a construction project.

2. Background Art

A problem that has plagued the construction industry for decades is that of protecting vegetation, and particularly relatively mature trees, during construction projects. Mature trees, such as certain types of oaks, have an extensive fibrous root network within several inches of the ground surface over a substantial area around their trunks. To avoid damage to these trees, it is essential that the soil, within which these fibrous roots are embedded, be kept in a relatively uncompacted state to allow water and other nutrients to be absorbed therethrough.

During many construction projects it is necessary to move heavy equipment directly over this root structure. This may occur during home construction, during a rehab project, or during the performance of some relatively extensive maintenance projects. It may be desirable to pass relatively heavy equipment over the tree roots during other projects, such as landscaping or during moving projects. If proper care is not taken, mature trees can be killed, or severely stressed or damaged, in a relatively short time period by heavy traffic.

It is common to view construction sites at which one or more mature trees have been adversely affected by construction crews. Home and business owners that select wooded sites are becoming increasingly diligent in avoiding this type of tree damage. Beyond this, many communities that have wooded sites have enacted legislation to restrict activities around mature trees.

The interest in landowners and communities in preserving their trees has led to efforts, primarily in the construction industry, to devise ways to protect the trees, while at the same time allowing heavy traffic that may be desirable for the performance of a particular task, and might otherwise inflict root change. Construction costs may be significantly affected by the allowable ingress and egress of heavy equipment at a particular site. Landowners may be forced to balance between spending a relatively large amount of money to allow construction workers to maneuver safely around trees and risking that the trees will not be traumatized by a somewhat liberal approach to accommodating construction traffic in the vicinity of the trees.

One common practice utilized by those in the construction trade has been to deposit a significant thickness of mulch on the ground over which heavy equipment will be traveling. The mulch distributes loading over a substantial area to avoid potentially damaging force concentration. Mulch application is commonly encouraged by arborists in that the mulch tends to absorb and retain moisture in a healthy manner, while at the same time allowing the roots to “breathe”. To be effective, this process requires that the mulch be applied and maintained at a safe level throughout a project. Typically, the mulch will be placed over a lawn from which the mulch will commonly be removed after a project is completed.

Maintaining a safe level of mulch throughout a project is inherently difficult. With regular travel thereover, there is a tendency of the mulch to shift. As this occurs, ruts may form at which the tree root structure again becomes dangerously exposed.

Another drawback with the use of mulch is that the removal thereof is inconvenient. Once a project is completed, the landowner and/or construction personnel are required to accumulate and appropriately dispose of the mulch.

In the interest of maximizing profits, those in the construction industry will commonly attempt to implement a system that is economically feasible and the least labor intensive. Inevitably, in striving for efficiency, shortcuts may be taken in terms of setting up and maintaining the safeguards, as a result of which trees may be damaged. Aside from the potential economic exposure that construction personnel face by reason of inflicting such damage, the landowner is faced with the consequence that such trees, depending upon their age, may be unreplaceable. A site that is selected for its tree population, may lose its appeal if trees are damaged or killed.

The construction industry continues to seek out methods that are effective in preserving trees during construction projects, while at the same time allowing movement of equipment conventionally at or adjacent to trees in such a manner that construction costs can be reasonably controlled.

### SUMMARY OF THE INVENTION

In one form, the invention is directed to a method of operating equipment around trees. The method includes the steps of: providing a plurality of modules; joining the plurality of modules to each other in an operative state at a site wherein the plurality of modules are placed against a ground surface over roots of at least one adjacent tree so that water can be directed at least one of (a) through at least one of the joined modules and (b) between the joined modules to against, and evaporated from, the ground surface; moving equipment against the plurality of joined modules so that weight forces for the equipment are distributed through the plurality of modules over a substantial area of the ground surface to avoid application of concentrated forces that may inflict damage to the tree roots; and removing the plurality of modules from the site after moving the equipment from against the plurality of joined modules.

In one form, the step of providing a plurality of modules involves providing a first module in the form of a sheet having a top, substantially flat surface, and a bottom surface. There is at least one opening extending fully through the first module between the top and bottom surfaces that allows water to be directed therethrough to against, and evaporated from, the ground surface with the first module in its operative state.

The step of providing a plurality of modules may involve providing a second module that is joined to the first module. The second module has a top ramp surface to facilitate movement of the equipment to upon the top surface of the first module.

The step of providing a first module may involve providing a first module with a grid defining a plurality of openings extending fully through the first module between the top and bottom surfaces over a substantial area of both the top and bottom surfaces of the first module.

The method may further include the step of providing a first connector on a first module in the plurality of modules. The step of joining the plurality of modules may involve operatively engaging the first connector with a second module in the plurality of modules.

The step of providing a first connector may involve providing a first connector that is separate from the first module and operatively engaging the first connector with the first module.

In one form, the first module has a peripheral edge and the step of operatively engaging the first connector with the first module involves operatively engaging the first connector at the peripheral edge of the first module.

In one form, the second module has a peripheral edge and the step of operatively engaging the first connector with the second module involves operatively engaging the first connector at the peripheral edge of the second module.

The step of operatively engaging the first connector with the second module may involve directing the first connector into an opening through the peripheral edge of the second module.

The step of directing the first connector into an opening may involve directing the first connector into an opening so that the first connector is keyed in the opening against movement around a first line.

The step of providing a plurality of modules may involve providing a plurality of modules each in the form of a sheet having a thickness on the order of ½ inch to 4 inches.

The step of providing a plurality of modules may involve providing a plurality of modules made from a molded plastic material.

The step of providing a plurality of modules may involve providing a plurality of modules with polygonally-shaped peripheral edges. The step of joining the plurality of modules may involve placing the peripheral edges on adjacent modules in adjacent or abutting relationship so that the plurality of modules collectively reside over a substantial area of the ground surface.

In one form, the step of providing a plurality of modules involves providing a plurality of modules each with a substantially flat top surface, with the top surfaces of the plurality of joined modules cooperatively defining a substantially continuously extending upwardly facing surface that can be acted against by the equipment.

The step of providing a plurality of modules may involve providing a first module with a discrete locating projection that is directed through the ground surface with the first module in the operative state.

The invention is further directed to a system for placement against a ground surface over tree roots and which is capable of distributing downward forces sufficiently to avoid imparting of forces that may inflict damage upon the tree roots. The system includes first and second modules each having a top surface and a bottom surface. The first module is placed in an operative state wherein the bottom surface bears against the ground surface and the top surface faces upwardly. The first and second modules are joined, each to the other, so as to maintain the first and second modules in a desired relationship with each other. The first and second modules are joined so that water can be directed at least one of (a) through the first module and (b) between the joined modules to be directed against, and evaporated from, the ground surface.

In one form, the first and second modules have peripheral edges and the first and second modules are joined to each other at the peripheral edges.

In one form, a first connector on the first module is directed into an opening in the peripheral edge on the second module.

In one form, the first connector and the opening in the peripheral edge on the second module are relatively configured to key the first connector within the opening against relative movement around a first line.

The first connector may be fixedly attached, or releasably joined, to the first module.

In one form, the first module is in the form of a sheet.

The top surface on the second module may be an angled ramp surface.

In one form, the first module is made from molded plastic.

The first module may have a thickness between the top and bottom surfaces on the order of ½ inch to 4 inches.

The first module may have a polygonal shape defined by the peripheral edge.

In one form, the first module has at least one opening extending fully through the first module between the top and bottom surfaces that allows passage of water.

The first and second modules may be releasably joined by press fit connectors.

In one form, the peripheral edge on the second module fully surrounds the first connector.

### BRIEF DESCRIPTION OF THE DRAWINGS

FIG. 1 is a flow diagram representation of a method of operating equipment around trees, according to the present invention;

FIG. 2 is a perspective view of a site at which a mature tree is located and with a system, according to the invention, for distributing downward forces, set up and including joined modules to cooperatively define an upwardly facing surface;

FIG. 3 is an enlarged, perspective view of one of the modules on the system in FIG. 2;

FIG. 4 is an enlarged, exploded, perspective view of a plurality of the modules in FIG. 3 arranged to be joined through separate connectors and with one of the modules aligned for joining a ramp module;

FIG. 5 is an enlarged, plan view of the module in FIG. 3;

FIG. 6 is an enlarged, elevation view along one peripheral edge portion on the module in FIG. 5;

FIG. 7 is a view as in FIG. 6 at a transverse peripheral edge portion;

FIG. 8 is an enlarged, cross-sectional view of joined modules taken along line 8-8 of FIG. 4;

FIG. 9 is a schematic, plan representation of one manner of joining a series of the modules in FIG. 3;

FIG. 10 is a perspective view of joined modules wherein the modules are slightly spaced to allow moisture to pass therebetween;

FIG. 11 is an enlarged, fragmentary, cross-sectional view of a pair of modules that are joined through a modified form of connector, that is keyed to each of the joined modules;

FIG. 12 is a schematic representation of a pair of modules joined through a separate connector;

FIG. 13 is a view as in FIG. 12 wherein a connector is integral with one of the joined modules;

FIG. 14 is an exploded, fragmentary, elevation view of a pair of modules joined through another type of connector;

FIG. 15 is a view of a module, as in FIG. 6, with a modified form of connector opening;

FIG. 16 is a partially schematic, plan view of another form of module having a different type of connector opening and showing a modified form of connector in schematic form;

FIG. 17 is a schematic, plan view of a plurality of modules joined utilizing modules and connectors as shown in FIG. 16;

FIG. 18 is an enlarged, perspective view of another one of the modules used on the system in FIG. 2;

FIG. 19 is a perspective view of a further modified form of module, according to the present invention;

FIG. 20 is an end elevation view of a further modified form of connector for joining adjacent modules; and

FIG. 21 is a view as in FIG. 20 of a still further modified form of connector, according to the present invention.

### DETAILED DESCRIPTION OF THE DRAWINGS

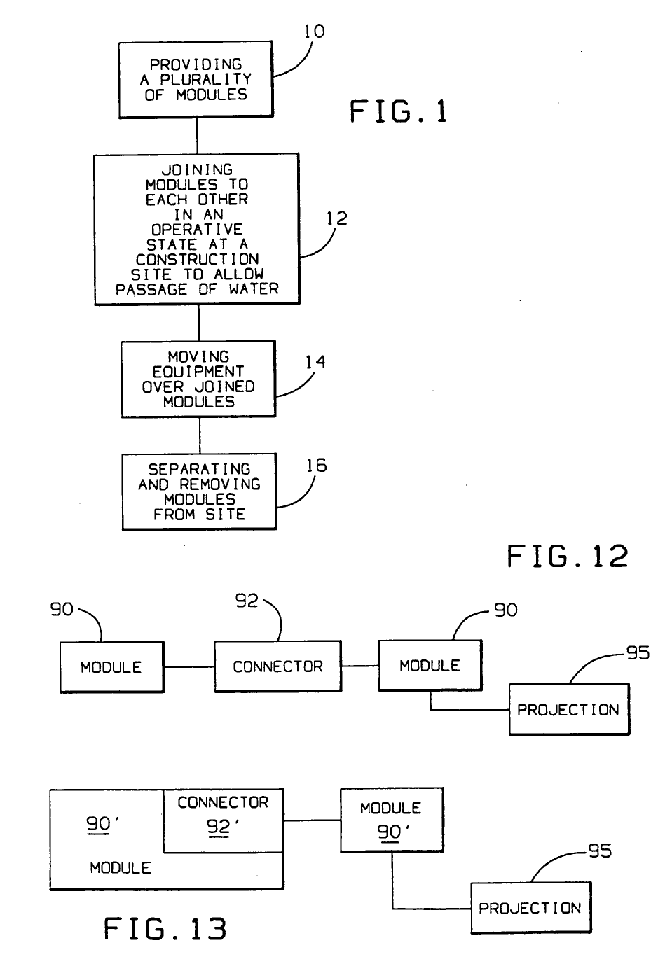

In FIG. 1, a method of operating equipment around trees, such as at a construction site, according to the present invention, is shown in flow diagram form. For purposes of the description herein, the site will be described as a “construction” site. However, this is intended to encompass any site at which heavy equipment is used, whether or not the activity relates to construction. The “equipment” may be any object that is caused to be moved over the site in the vicinity of a tree.

According to the invention, a plurality of modules are provided, as shown at block 10. As shown at block 12, the modules are joined to each other in an operative state at a construction site so as to cover a substantial area of a ground surface around vegetation, such as mature trees, so as to allow passage of water through and/or around the joined modules so that the water can be directed to against, and be evaporated from, the ground surface with the joined modules in their operative state. Once the modules are joined and in their operative state, equipment, such as commonly used at construction sites, or for any other task, can be directed over the joined modules, as shown at block 14. Once it is no longer necessary for the equipment to be directed over the ground surface in the vicinity of the trees, the modules can be separated and removed from the site, as shown at block 16.

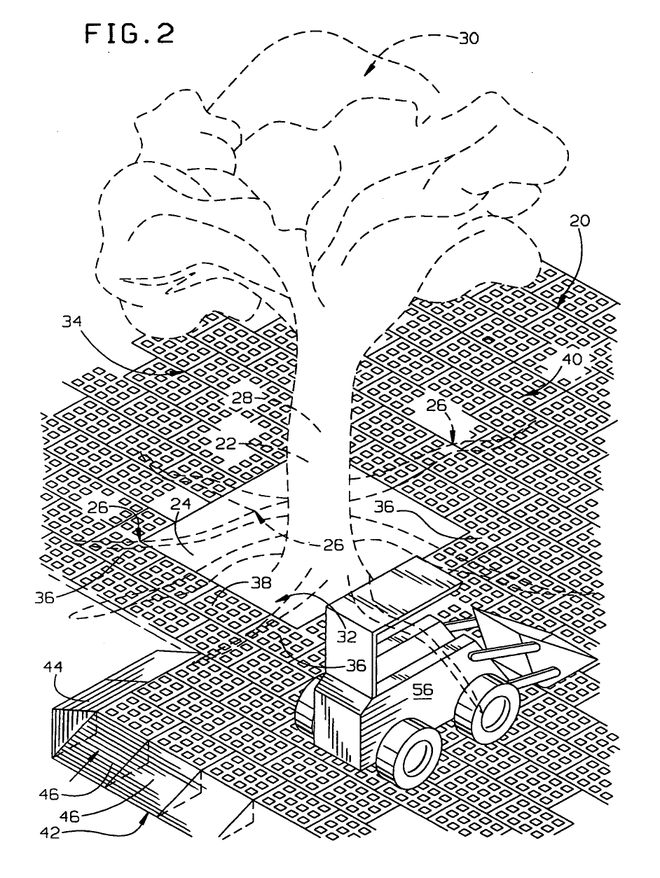

In FIG. 2, a typical site contemplated for use of the present invention, is shown at 20. At this site, a mature tree 22 projects from a ground surface 24. Typically, certain species of trees will have fibrous roots, or a similar type of root structure, as shown at 26, through which moisture and other nutrients are fed to the tree trunk 28 and therethrough to the branches and leaves at 30. To avoid damage to the tree 22, it is important that the ground at 32, within which the root structure 26 is embedded, not be compacted excessively. According to the invention, a system at 34 is placed against the ground surface 24 to distribute downward forces applied thereto sufficiently to avoid imparting of forces of a magnitude that may immediately, or over time, inflict damage to the tree root structure at 26.

More specifically, the system 34 is made up of a plurality of modules, in this particular system shown with four different constructions. The modules are shown in sheet form, though this is not a requirement. The first module 36 is in the form of a corner, with a second module 38 being squared/rectangular in shape. The modules 36,38 are joined to produce a network 40 covering a substantial area of the ground surface 24. At the peripheral edge of the network 40, a ramp edge at 42 is formed. The ramp edge 42 is defined by a third module 44 that defines a corner, and a fourth module 46 joinable to the first, second and third modules 36, 38,44, and to other of the fourth modules 46, to produce the ramp edge 42.

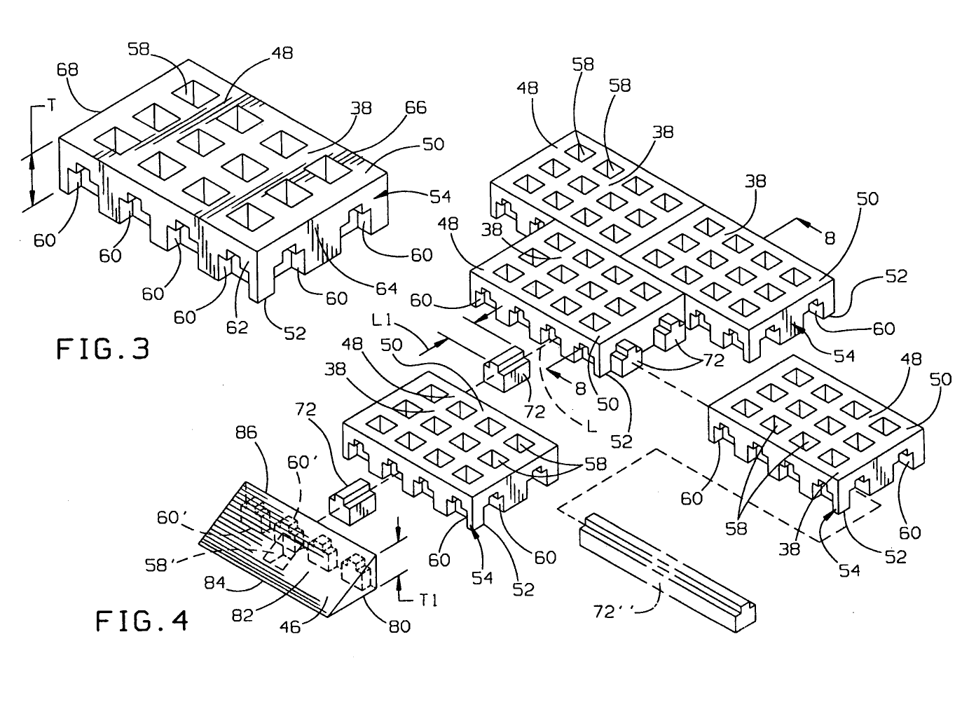

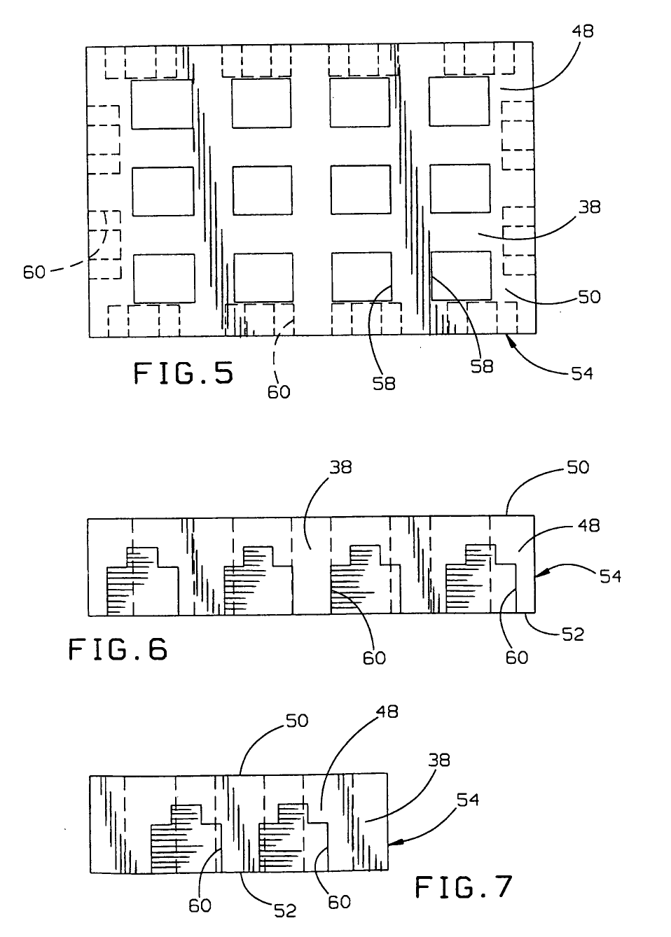

One exemplary construction for the second modules 38 is shown in FIGS. 3-8. The module 38 consists of a body 48 with a top surface 50, a bottom surface 52, and a peripheral edge 54. In this particularly embodiment, the body 48 has a rectangular shape bounded by the peripheral edge 54. The rectangular shape is not critical to the present invention. It is preferred that the shape be polygonal to facilitate abutting or adjacent alignment of the modules 38 throughout the network 40. However, virtually any other shape is contemplated that allows joining of modules in sufficiently close proximity that a heavy piece of equipment, as shown at 56 in FIG. 2, traversing the site 20, will not directly contact the ground surface 24 throughout the network 40. The top surface 50 is substantially flat and sufficiently continuous that there are not large gaps, so as to thereby facilitate foot travel and movement of equipment thereover. “Continuous” does not require contiguity but is meant to define a surface without large gaps at which the ground surface is exposed and may be contacted by equipment passing over the site 20.

In one preferred form, the body 48 has a vertical thickness T in the range of ½ to 4 inches. The thickness T may be dictated in part by the nature of the material that is used. It is preferred that the modules 38 have a certain degree of flexibility to conform to irregularities in the ground surface 24, yet have sufficient rigidity that they will distribute applied forces over a substantial area without excessive bending or cracking. The modules 38 lend themselves to being molded from plastic, or other types of material well known to those skilled in this art.

In the embodiment shown, the body 48 has a substantially solid construction between the top and bottom surfaces 50,52 so that the bottom surface 52 is substantially flat. A regular arrangement of openings 58 is formed fully between the top and bottom surfaces 50,52 to allow water to be directed therethrough to against, and evaporate from, the ground surface 24 against which the module 38 is placed. The number, size, shape, and arrangement of the openings 58 may vary depending upon the particular application. It is desired that the openings 58 be arranged in a grid so as to allow the passage of a significant volume of water, whereby adequate moisture can be delivered to the root structure 26 and evaporated therefrom to avoid root rot, as might otherwise occur during an extended period that the modules 38 are in place. The area of the openings 58 is limited only so as not to adversely affect the integrity of the modules 38. In the embodiment shown, the openings 58 are arranged to occupy approximately 25-50% of the area of the top and bottom surfaces 50, 52.

Connector openings 60 are provided through each of peripheral edge portions 62,64,66,68 that cooperatively define the peripheral edge 54. The connector openings 60 are configured, and have a sufficient depth, to accommodate discrete connectors 72. In this particular embodiment, the connectors 72 have an inverted T shape which is directable into the connector openings 60, which have a complementary shape so that the connectors 72 are keyed against movement relative to the modules about a reference line L (FIG. 4).

The connectors 72 have a sufficient length L1 (FIG. 4) to allow them to penetrate connector openings 60 in adjacent modules 38 to thereby join the adjacent modules 38. More specifically, connector openings 60 on adjacent modules 38 can be aligned, as shown in FIG. 4. The connectors 72 can be directed through one or more of the aligned connector openings 60 to join the adjacent modules 38. With the construction shown, preferably the connectors 72 are directed into one or more connector openings 60 at each peripheral edge portion 62, 64, 66, 68 to connect adjacent modules 38. One of the modules 38 is initially placed on the ground surface 24 over the connector(s) 72. Thereafter, the adjacent module 38 can be placed over the protruding portions of the connector(s) 72 to seat the same in the connector openings 60. Alternatively, the connectors 72 can be placed on the ground surface 24 after which both of adjacent modules 38 are lowered over the connectors 72.

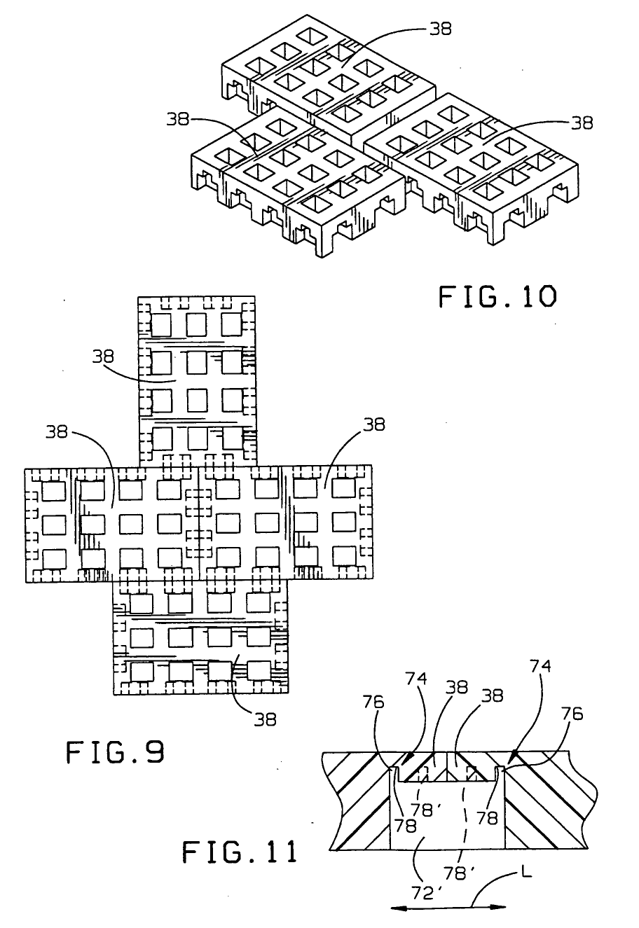

The connector openings 60 are preferably spaced so that the modules 38 can be joined in aligned rows, or in a staggered relationship, as shown schematically in FIG. 9, to produce a higher integrity interlocking effect. FIG. 9 represents only one staggered arrangement of the modules 38 that is contemplated.

The modules 38 can be placed in abutting edge-to-edge relationship, or spaced slightly from each other, as shown in FIG. 10. With the arrangement in FIG. 10, passage of water is allowed between the adjacent modules 38 in addition to that which may pass through the associated openings 58. The arrangement in FIG. 10 potentially obviates the need to include the openings 58.

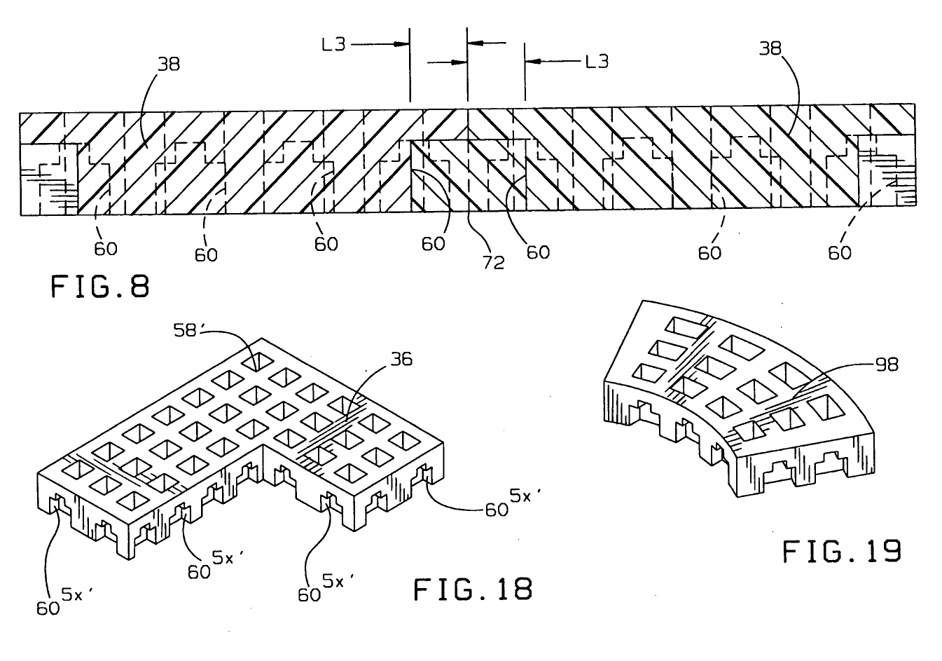

As seen in FIG. 8, the connector openings 60 may have a horizontal depth L3 that is equal to approximately one half the length L1. This allows a consistent penetrated relationship to be established between each of the connectors 72 and the openings 60.

It is also contemplated, as shown in FIG. 11, that some sort of secondary keying structure may be provided between connectors 72′ and the modules 38 at 74 to consistently establish a relationship between the connectors 72′ and modules 38, while preventing separation of the joined modules 38 along the line L. In the embodiment shown, the connector 72′ has projections 76 which are received, one each, in complementary receptacles 78 in the modules 38. This limits relative movement of the connectors 72′ and modules 38 along the line L with the connectors 72 operatively positioned. Optional receptacles 78′ can be provided in the modules 38 to accept the projections 76 with the modules 38 spaced slightly from each other.

The modules 46 are joinable to the modules 38, preferably using the connectors 72. As shown in FIG. 4, the module 46 has a bottom surface 80 and a top, ramped surface 82. The top surface 82 tapers from an entry edge 84 to a thickness T1 that is approximately equal to the thickness T for the modules 38. The module 46 has a peripheral edge portion 86 that is abuttable to one of the peripheral edge portions 62,64,68,70 of the modules 38. Connector openings 60′ are formed through the peripheral edge portion 86 to accommodate the connectors 72 in the same manner that the openings 60 accommodate the connectors 72. Optional water passage openings 58′ (one shown in dotted lines), may be formed through the module 46.

Many variations from the basic structures, as described above, are contemplated by the invention. All that is required is that a stable network of modules be definable to distribute loading forces and allow ingress and egress of water through and/or around the modules. The specific manner of connecting the modules is not critical to the present invention.

FIG. 12 is a schematic representation of two modules 90, intended to generically represent all different module designs, including, but limited to, the modules 36,38,44,46, described above, and joined through a generic type of a connector 92. The only criticality is that the connector 92 join the modules 90 so that the modules are against each other or in close proximity so there is not a significant gap therebetween that allows the ground surface 24 to be undesirably contacted and compacted under applied forces. In this embodiment, the connector 92 is shown to be separate from the modules 90.

The same type of generic representation of the inventive system is shown in FIG. 13 with modules 90′, wherein the connector 92′ is integrally formed with one of the modules 90′.

Another exemplary type of connector 92 is shown in FIG. 14 in the form of a U shape that can be pressed into a complementary receptacle 94 defined cooperatively by the modules 90.

As shown in FIGS. 12 and 13, one or more discrete projections 95 can be formed on at least one of the modules 90, 90′ for direction into the ground to hold the modules 90, 90′ firmly in place.

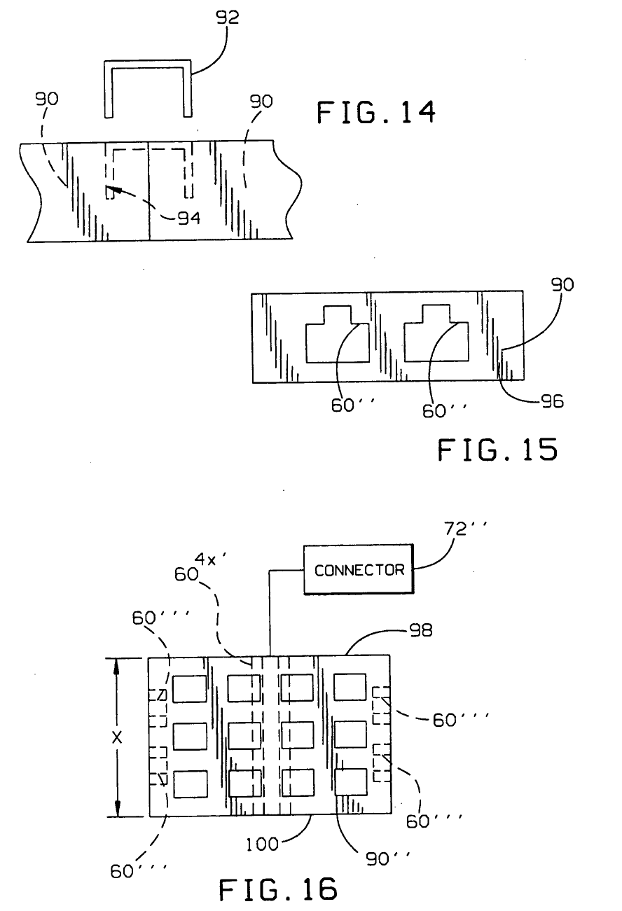

In another variation, as shown in FIG. 15, the module 90 may have openings 60″, corresponding to the openings 60, that are fully surrounded by the body 96 of the module 90. With this arrangement, the modules 90 cannot be lowered onto the connectors 72. Instead, the connectors 72 must be directed horizontally into the openings 60″.

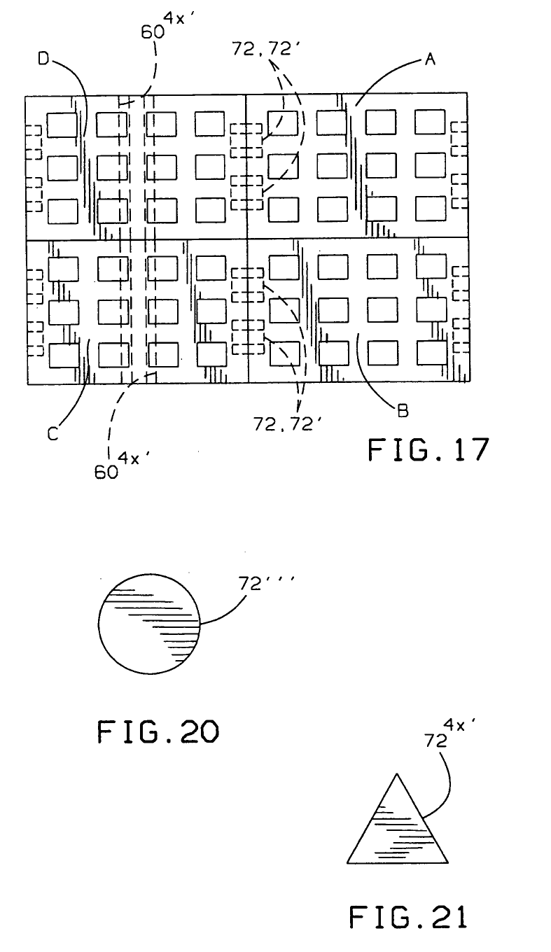

One variation of the module 90 is shown at 90″ in FIG. 16. The module 90″ has openings 60′″ extending only partially therethrough and an opening 60^{4x}′ extending fully therethrough to accommodate a connector 72″ (see also FIG. 4), that can extend fully through the dimension X so as to be exposed at oppositely facing peripheral edge portions 98,100. The through opening 60^{4x}′ is necessary at connections as shown in FIG. 17. As shown in FIG. 17, modules A, B and C may be joined using the shorter connectors 72,72′. The module D could be joined to one of the modules A,C using the shorter connector 72,72′ but would require use of the longer connector 72″ to connect to the other of the modules A,C.

The module 36 is shown in greater detail in FIG. 18 and has the same functional components as the module 38, but is made in the shape of an L to form a suitable corner. That is, the module 36 has the aforementioned moisture openings 58′ and connector openings 60^{5x}′, corresponding to the openings 58,60, respectively.

As noted previously, the modules 90,90′ can have virtually any shape that facilitates interconnection, be it polygonal, or otherwise. In FIG. 19, a curved module 98 is shown, as just one other exemplary shape.

It is also contemplated that the openings for the various connectors have other shapes which effect keying or do not key joined elements. As one example, in FIG. 20, a connector 72′″ is shown to have a circular shape, as viewed from the end. In FIG. 21, a connector 72^{4x}′ is shown with a triangular shape. These are just intended to be exemplary in nature, as virtually a limitless number of different shapes could be utilized in complementarily-shaped openings.

While the invention has been described with particular reference to the drawings, it should be understood that various modifications could be made without departing from the spirit and scope of the present invention.

1. A method of operating equipment around trees, the method comprising the steps of:
providing a plurality of modules;
joining the plurality of modules to each other in an operative state at a site wherein the plurality of modules are placed against a ground surface over roots of at least one adjacent tree so that water can be directed at least one of (a) through at least one of the joined modules and (b) between the joined modules, to be directed against, and evaporated from, the ground surface;
moving equipment against the plurality of joined modules so that weight forces for the equipment are distributed through the plurality of modules over a substantial area of the ground surface to avoid application of concentrated forces that may inflict damage to the tree roots; and
removing the plurality of modules from the site after moving the equipment from against the plurality of joined modules.

2. The method of operating equipment around trees according to claim 1 wherein the step of providing a plurality of modules comprises providing a first module in the form of a sheet having a top, substantially flat surface and a bottom surface, and there is at least one opening extending fully through the first module between the top and bottom surfaces that allows water to be directed therethrough to against, and evaporated from, the ground surface with the first module in the operative state.

3. The method of operating equipment around trees according to claim 2 wherein the step of providing a plurality of modules comprises providing a second module that is joined to the first module, the second module having a top ramp surface to facilitate movement of the equipment to upon the top surface of the first module.

4. The method of operating equipment around trees according to claim 2 wherein the step of providing a first module comprises providing a first module with a grid defining a plurality of openings extending fully through the first module between the top and bottom surfaces over a substantial area of both the top and bottom surfaces of the first module.

5. The method of operating equipment around trees according to claim 1 further comprising the step of providing a first connector on a first module in the plurality of modules, and the step of joining the plurality of modules comprises operatively engaging the first connector to a second module in the plurality of modules.

6. The method of operating equipment around trees according to claim 5 wherein the step of providing a first connector comprises providing a first connector that is separate from the first module and operatively engaging the first connector with the first module.

7. The method of operating equipment around trees according to claim 6 wherein the first module has a peripheral edge and the step of operatively engaging the first connector with the first module comprises operatively engaging the first connector at the peripheral edge of the first module.

8. The method of operating equipment around trees according to claim 6 wherein the second module has a peripheral edge and the step of operatively engaging the first connector to the second module comprises operatively engaging the first connector at the peripheral edge of the second module.

9. The method of operating equipment around trees according to claim 8 wherein the step of operatively engaging the first connector to the second module comprises directing the first connector into an opening through the peripheral edge of the second module.

10. The method of operating equipment around trees according to claim 9 wherein the step of directing the first connector into an opening comprises directing the first connector into an opening so that the first connector is keyed in the opening against movement around a first line.

11. The method of operating equipment around trees according to claim 1 wherein the step of providing a plurality of modules comprises providing a plurality of modules each in the form of a sheet having a thickness on the order of ½ inch to 4 inches.

12. The method of operating equipment around trees according to claim 1 wherein the step of providing a plurality of modules comprises providing a plurality of modules made from a molded plastic material.

13. The method of operating equipment around trees according to claim 1 wherein the step of providing a plurality of modules comprises providing a plurality of modules with polygonally-shaped peripheral edges and the step of joining the plurality of modules comprises placing the peripheral edges on adjacent modules in adjacent or abutting relationship so that the plurality of modules collectively reside over the substantial area of the ground surface.

14. The method of operating equipment around trees according to claim 13 wherein the step of providing a plurality of modules comprises providing a plurality of modules each with a substantially flat top surface and the top surfaces of the plurality of joined modules cooperatively define a substantially continuously extending, upwardly facing surface that can be acted against by the equipment.

15. The method of operating equipment around trees according to claim 1 wherein the step of providing a plurality of modules comprises providing a first module with a discrete locating projection that is directed through the ground surface with the first module in the operative state.

16. A system for placement against a ground surface over tree roots and which is capable of distributing downward forces sufficiently to avoid imparting of forces that may inflict damage upon the tree roots, said system comprising:
first and second modules each having a top surface and a bottom surface,
the first module placed in an operative state wherein the bottom surface bears against the ground surface and the top surface faces upwardly,
the first and second modules joined, each to the other, so as to maintain the first and second modules in a desired relationship to each other,
the first and second modules joined so that water can be directed at least one of (a) through the first module and (b) between the joined modules to be directed against, and evaporated from, the ground surface.

17. The system for placement against a ground surface over tree roots according to claim 16 wherein the first and second modules have peripheral edges and the first and second modules are joined to each other at the peripheral edges.

18. The system for placement against a ground surface over tree roots according to claim 17 wherein a first connector on the first module is directed into an opening in the peripheral edge on the second module.

19. The system for placement against a ground surface over tree roots according to claim 18 wherein the first connector and the opening in the peripheral edge on the second module are relatively configured to key the first connector within the opening against relative movement around a first line.

20. The system for placement against a ground surface over tree roots according to claim 18 wherein the first connector is fixedly attached to the first module.

21. The system for placement against a ground surface over tree roots according to claim 18 wherein the first connector is releasably joined to the first module.

22. The system for placement against a ground surface over tree roots according to claim 16 wherein the first module is in the form of a sheet.

23. The system for placement against a ground surface over tree roots according to claim 22 wherein the top surface on the second module is an angled ramp surface.

24. The system for placement against a ground surface over tree roots according to claim 16 wherein the first module comprises molded plastic.

25. The system for placement against a ground surface over tree roots according to claim 16 wherein the first module has a thickness between its top and bottom surface, on the order of ½ inch to 4 inches.

26. The system for placement against a ground surface over tree roots according to claim 17 wherein the first module has a polygonal shape defined by the peripheral edge.

27. The system for placement against a ground surface over tree roots according to claim 16 wherein the first module has at least one opening extending fully through the first module between the top and bottom surfaces that allow passage of water.

28. The system for placement against a ground surface over tree roots according to claim 16 wherein the first and second modules are releasably joined by press fit connectors.

29. The system for placement against a ground surface over tree roots according to claim 19 wherein the peripheral edge on the second module fully surrounds the first connector.
